(19) United States
(12) Patent Application Publication
(10) Pub. No.: US 2012/0070627 A1
(43) Pub. Date: Mar. 22, 2012

(54) METHOD FOR NANOPATTERNING BASED ON SELF ASSEMBLY OF A TRIBLOCK TERPOLYMER

(75) Inventors: Peng-Wei Chuang, Natick, MA (US); Caroline A. Ross, Arlington, MA (US); Edwin L. Thomas, Natick, MA (US)

(73) Assignee: Massachusetts Institute of Technology, Cambridge, MA (US)

(21) Appl. No.: 12/884,600

(22) Filed: Sep. 17, 2010

(51) Int. Cl. B32B 3/10; B05D 3/00; B82Y 30/00

(52) U.S. Cl. 428/195.1; 427/331; 977/755; 977/789; 977/902

(57) ABSTRACT

Nanolithography and nanoscale device features based on a self-assembled film comprising an ABC triblock terpolymer disposed on a substrate surface are provided. The self-assembled film has a controlled pattern of features over the entire film. Each feature comprises block A, block B, or block C of the ABC triblock terpolymer. One or more blocks (A, B, or C) of the self-assembled film can be transformed by, for example, being removed, to provide a particular pattern geometry for nanolithography.

### BACKGROUND OF THE INVENTION

Diblock and triblock copolymers and triblock terpolymers have become a focus of study for nanolithography and nanoscale device fabrication due to their ability to create nanoscale self-assembled patterns.

Diblock copolymers are linear copolymers where two dissimilar repeating units or combination of repeating units form two isolated sequences—blocks—coupled together by a single bond or unit. Usually, a first block (block A) that is a chain of N_{A} repeating units of type A is covalently linked to at least a second block (block B) that is a chain of N_{B} repeating units of type B. When these two blocks are sufficiently dissimilar in structure, mixing of the blocks does not occur and they separate into different phases. Microphase separation of diblock copolymers depends on one composition variable, the volume fraction of block, and on the Flory-Huggins interaction parameter χ_{AB} between blocks A and B. Diblock polymers, where the blocks are of the appropriate volume fraction and size, self assemble to display various morphologies, which include blocks separated to form isolated cylindrical phases of one block separated by a continuous phase of the other block. This morphology can form when the block copolymer is deposited on a surface by spin coating or other deposition methods and generates, for example, a structure consisting of a close-packed hexagonal arrangement of vertically aligned cylinders when a “neutral” surface is employed. Such self-assembled patterns have been studied extensively as templates for lithography, where hexagonal arrays of ‘dots’, pillars or holes extend from an underlying functional film.

A triblock copolymer is a block copolymer where a third block, which can be the same or different than one of the other blocks, for example as ABA or ABC, is included. The AB diblock and ABA triblock copolymers will exhibit only one morphology from the available morphologies of spheres, cylinders, gyroids or lamellae during microphase separation. In contrast, for ABC triblock terpolymers, there are five independent parameters that determine the equilibrium structure during microphase separation. In particular, there exist two independent segment compositions, fraction A and fraction B, and three Flory interaction parameters, χ_{AB}, χ_{BC}, and χ_{AC} that define the resulting morphology. Unlike the case of the AB diblock and ABA triblock copolymers, ABC triblock terpolymers allow for a wide range of different microphase separated morphologies. For example, spheres within lamellae, lamellae with spheres at the interfaces, lamellae of three different blocks, core-shell spheres, core-shell cylinders, and other phase separated structures can form by self-assembly of triblock terpolymers.

Hexagonally packed core-shell cylinders from triblock terpolymers having two etchable blocks, poly(isoprene-block-styrene-block-lactide), for potential self-assembled lithographic processes has been disclosed in Guo et al., Chem. Mater. 18, 2006, 1719. A more desirable possibility for terpolymers is to have a square array of features as disclosed in Phan et al. Macromolecules 31, 1998, 59, where modeling suggests that ABC triblock terpolymers can form a more stable square lattice of A and C spheres in a B matrix when compared to the hexagonal equivalent. A square array of two compositionally different cylinders has been observed in Mogi et al., Macromolecules 25, 1992 5048 and Jung et al., Macromolecules 29, 1996, 1076 for portions of an approximately 200 μm thick poly(isoprene-block-styrene-block-2-vinylpyidine) and within a bulk poly(styrene-block-butadiene-block-methyl methacrylate), respectively.

However, there continues to be a need in the art for methods and films capable of self-assembling to form structures with application to microelectronics and nanoscale device fabrication. By forming a square array, self-assembled patterned films could fulfill many possible applications in microelectronics, including magnetic storage devices, and other fields if the terpolymers include blocks that, after microphase separation, can be modified, removed, or replaced with materials with desired properties, particularly when the different blocks can be transformed independently. Hence, the production of a triblock terpolymer film with a square array cross-section of dissimilar sub-50 nm cylinders is a desirable self-assembling system for lithography, particularly where a desired specific orientation can be imposed on the different cylinders within the patterned material over all of a desired surface.

### BRIEF SUMMARY

Embodiments of the invention provide self-assembled nanolithography and nanoscale device features using an ABC triblock terpolymer comprising film. In accordance with certain embodiments of the invention, triblock terpolymer systems are provided that include polymer blocks that can be modified, removed, or replaced with materials with desired properties. The subject self-assembled systems can be used for a variety microelectronics applications, including magnetic storage devices.

Methods are also provided to impose a desired specific orientation of different cylinders within the self-assembled ABC triblock terpolymer comprising film over all of a desired surface. Certain embodiments of the invention provide methods to control the film's pattern by the triblock terpolymer composition and the templating and orienting of the pattern by the features of the substrate and the relative affinity of the various blocks of the triblock terpolymer to the material comprising the surfaces of the substrate's features upon which the triblock terpolymer comprising thin film is deposited. In one embodiment of the invention, the self assembled thin films display a square array of columns perpendicular to a substrate surface upon which it is deposited.

According to a further embodiment of the invention, in addition to an ABC triblock terpolymer, the films can include homopolymers of one or more of the blocks or of a different material, and may include AB, BC, or AC diblock copolymers. The triblock terpolymer comprising thin films can be deposited by spin-coating, spray-coating, dip-coating or any other thin film deposition technique using the triblock terpolymer in a liquid state, for example in solution. Once it has microphase separated, the thin film can have one or more of the blocks transformed by modification, removal, and/or replacement to yield features that can be used for a microelectronic or other device after the transformation or upon one or more additional subsequent or simultaneous transformations.

### BRIEF DESCRIPTION OF THE DRAWINGS

The accompanying drawing figures incorporated in and forming a part of this specification illustrate several aspects of the invention, and together with the description serve to explain the principles of the invention.

FIGS. 1A-1D show drawings of a top view of the bulk morphology of the ABC triblock terpolymer that forms a square array of columns where A is the small diameter columns, B the continuous phase around the columns and C the larger diameter columns, according to an embodiment of the invention (FIG. 1A), and where the triblock terpolymer film is modified by the removal of the C block columns (FIG. 1B), the removal of the A block columns (FIG. 1C), and the removal of all columns (FIG. 1D) to form a mask, according to an embodiment of the invention.

FIGS. 2A-2E show morphologies of a polyisoprene-block-polystyrene-block-polyferrocenylsilane (PI-b-PS-b-PFS) triblock terpolymer according to an embodiment of the invention where: FIG. 2A is a drawing of the bulk morphology showing PFS (dark) and PI (light) parallel cylinders forming a square lattice checkerboard pattern in a matrix of PS; FIG. 2B is a bright field TEM image of the bulk morphology of the pure triblock terpolymer where the dark spots represent sections through the PFS cylinders; FIG. 2C is a SEM image of a thin film of PI-b-PS-b-PFS as deposited on an oxidized Si surface and reactive ion etched (RIE) with oxygen to remove PI and PS blocks; FIGS. 2D and 2f are SEM image of a thin film of PI-b-PS-b-PFS blended with polystyrene (PS) according to an embodiment of the invention on an oxidized Si surface after reactive ion etching (RIE) with oxygen to remove PI and PS blocks; and FIG. 2E is a SEM image of a thin film of PI-b-PS-b-PFS blended with PS according to an embodiment of the invention, which was stained with OsO₄ for 4 hours before RIE to enhance the resistance of PI to the oxygen etch, where PFS shows as bright features and where PI appears as lighter features between the PFS features.

FIGS. 3A and 3B show a SEM image of a templated assembled film of a PI-b-PS-b-PFS/PS blend of about 30 nm thickness after annealing and oxygen RIE to remove the PI and PS domains, in which the triblock terpolymer is deposited on an uncoated trench surface according to an embodiment of the invention, and a SEM image of the equivalent PI-b-PS-b-PFS/PS blend assembly where the trench surface is coated by a PS-brush according to an embodiment of the invention, respectively, in accordance with an embodiment.

FIG. 3C shows a schematic of optional orientations of PI and PFS columns relative to trench walls in a PS-brushed trench where the row spacing Pₒ is defined for each orientation and the observed spacing between the outer PFS row and the trench wall is indicated in accordance with an embodiment.

FIG. 3D shows a plot of the number of rows of PFS columns for various confinement widths W normalized by row spacing P_{0.90} and P_{0.45} respectively for the 90 and the 45° orientations for arrays in PS-brushed trenches in accordance with an embodiment.

FIG. 3E shows a schematic of the 90° orientations possible in an uncoated trench where either the PI (left) or the PFS (right) wets the walls of the trench in accordance with an embodiment.

FIG. 3F shows a plot of number of rows of PFS columns for various confinement widths W normalized by row spacing P_{0.90} for the 90° orientation self-assembled in an uncoated trench in accordance with an embodiment.

FIGS. 4A-4C show SEM images of about 35 nm thick films after annealing and etching with oxygen RIE of PI-b-PS-b-PFS/PS blends, according to an embodiment of the invention, assembled in: a PS-brushed trench according to an embodiment of the invention where PFS cylinders reside perpendicular to the trench walls and terminate before the trench wall (FIG. 4A); about 35 nm thick films of a PI-b-PS-b-PFS/PS blend assembled on uncoated trenches of various relatively narrow widths according to embodiments of the invention having in-plane PFS cylinders parallel to the trench walls surrounding 90°-oriented out-of-plane PFS cylinder arrays (FIG. 4B); and about 35 nm thick films of a PI-b-PS-b-PFS/PS blend assembled on uncoated trenches of various relatively wide trenches having in-plane PFS cylinders parallel to the trench walls, often with branches, surrounding a mix of in-plane PFS cylinders and 45°-oriented and 90°-oriented out-of-plane PFS cylinder arrays (FIG. 4C).

FIG. 5A shows a schematic of a pattern transfer process according to an embodiment of the invention, where PFS posts after PI and PS removal from a thin film of a PI-b-PS-b-PFS/PS blend on silica are transformed into silica posts with PFS caps after CF₄ RIE and ultimately silica posts after removal of the PFS posts.

FIGS. 5B-5G show SEM images of stages of the pattern transfer process of FIG. 5A, where FIGS. 5B, 5C, and 5D show top view SEM images and FIGS. 5E, 5F, and 5G show the respective side views SEM images.

### DETAILED DISCLOSURE

Embodiments of the invention are directed to self-assembled ABC triblock terpolymers for the formation of patterns over the entire area of the thin film. Certain embodiments of the invention provide methods to control the film pattern by controlling the triblock terpolymer composition, the features of the substrate and the relative affinity of the various blocks of the triblock terpolymer to the material comprising the surfaces of the substrate's features upon which the ABC triblock terpolymer comprising thin film is deposited.

In one embodiment, at least one dimension of the self assembled features of the film, for example column diameters or lamella thicknesses, are similar to the film's thickness, which is less than about 50 nm for most uses envisioned for the self assembled thin films. The feature's dimension and the thickness can be referred to as being ‘similar’ where one is no more than twice that of the other. Larger dimensions are possible, as one or more larger blocks of the ABC triblock terpolymer allow large features, although for microelectronic and other applications many complementary and well established lithographic processes currently are practiced for features in excess of 50 nm and triblock terpolymers require significantly greater precision in their synthesis as the block sizes increase.

In one embodiment of the invention the self assembled thin film displays a square array of columns perpendicular to a substrate surface upon which it is deposited. According to further embodiments of the invention, in addition to an ABC triblock terpolymer, the films can include homopolymers of one or more of the blocks and may include AB, BC, or AC diblock copolymers. The triblock terpolymer comprising thin films can be deposited by spin-coating, spray-coating, dip-coating or any other thin film deposition technique using the triblock terpolymer in a liquid state, for example in solution. Once formed, the thin film can have one or more of the blocks transformed to yield features that can be used for a microelectronic or other device after the transformation or upon one or more additional subsequent or simultaneous transformations. As used herein, “transformation” refers to the modification of a feature within the ABC triblock terpolymer comprising film, for example doping or chemically transforming a block to an active polymeric material. Transformation can be a removal or replacement of one or more features of the ABC triblock terpolymer comprising film. For example, one or two of the blocks of the terpolymer can be etched or otherwise removed and used as a mask or template to replace the features of, for example, the square array with a conductive, semiconductive, or insulating material having the nanostructured features imposed by the self assembly of the triblock terpolymer. The ABC terpolymer can be formed by any method practiced in the art for the formation of ABC terpolymers, including but not limited to living or quasi-living addition polymerizations of vinyl or cyclic monomers by ionic, radical or coordination complex intermediates, as can be appreciated by those skilled in the art.

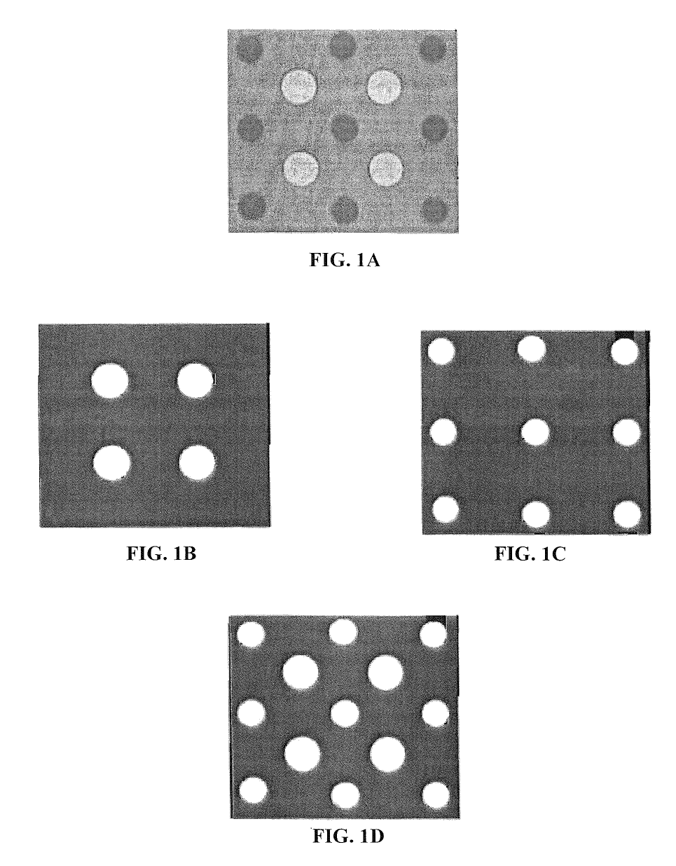

From the deposited ABC triblock terpolymer comprising film that self-assembles as a square array of columns, as shown in FIGS. 1A-1D, the columns from A blocks and/or the columns from C blocks, or both, may be removed leaving the continuous B block phase intact, to create a B film having isolated holes displaying a square symmetry, which, for example, can be used as an etch mask or as a mask for a liftoff process during fabrication of a microelectronic device. For example, with a polymethylmethacrylate-polystyrene-polybutadiene (PMMA-PS-PB) triblock terpolymer, deep UV exposure can be employed to simultaneously degrade the PMMA columns and cross-link the PS continuous phase. The degraded PMMA domains can be removed by reactive ion etching (RIE) using oxygen, to yield the pattern of holes shown in FIG. 1C. Alternately, or subsequently, UV/Ozone can be used to degrade the double bonds forming the 1,4-addition units of the PB backbone, followed by washing the degradation residues from the film to form the pattern of holes shown in FIG. 1B or 1D. The washing can be performed, for example, by immersing in water at 50° C. for 5 hours. Thus, a crosslinked, or alternately an uncrosslinked, polystyrene film containing holes in a desired specific square array arrangement can be achieved. By controlling the sizes and proportions of the three blocks, and by selecting between the two terminal blocks (A and C) to be removed, patterns with square arrays with various diameter of columns and/or holes, separation between columns and/or holes, distribution of column and/or hole diameters, and orientation of rows of columns and/or holes relative to an edge of a device can be generated as desired.

A square symmetry structure of the type that can be generated from the ABC triblock terpolymer comprising thin film, according to an embodiment of the invention, allows self-assembly of films with a close-packed structure other than those presently available, which display hexagonal symmetry. For example, the square symmetry avoids the geometrical magnetic frustration occurring in magnetostatically interacting nanoparticles fabricated in a hexagonal symmetry, which is relevant in magnetic data storage.

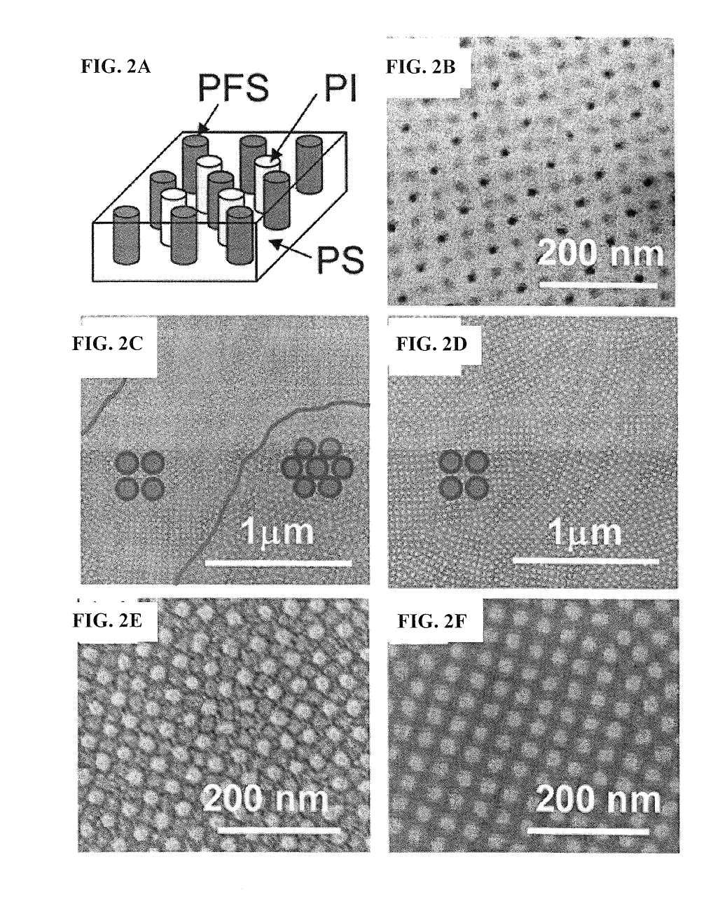

Thin films with square-packed A and C cylinders in a B matrix from an A-block-B-block-C triblock terpolymer can be formed when microphase separation occurs between the three blocks, as shown in FIGS. 2A and 2B. Microphase separation requires that the Flory-Huggins interaction parameter between the A and C blocks, χ_{AC}, the A and B blocks, χ_{AB}, and the B and C blocks, χ_{BC}, display a sufficient magnitude. In one embodiment of the invention, χ_{AC} is greater than χ_{AB} and χ_{BC}, and the largest volume fraction is that of the B block, for example 60-70% by volume. An exemplary triblock terpolymer that displays these conditions is polyisoprene-block-polystyrene-block-polyferrocenylsilane (PI-b-PS-b-PFS) where the volume fractions of the blocks are 25, 65, and 10%, respectively. The three interaction parameters calculated from the solubility parameters of PI, PS, and PFS are 17.0 (MPa)^{1/2}, 18.5 (MPa)^{1/2}, and 18.7 (MPa)^{1/2}, respectively. The PI-b-PS-b-PFS incorporates two organic (PI and PS) blocks and organometallic (PFS) block. The organometallic PFS block has an etch resistance to oxygen plasma that is much higher than that of the organic PI block, which allows a very high etch selectivity between these blocks. The etch selectivity of this ABC triblock terpolymer facilitates greater pattern transfer than that typical of known all-organic triblock terpolymers. The molecular weight of the exemplary PI-b-PS-b-PFS is 82,000 g/mol.

FIG. 2B shows a TEM image of the bulk morphology of the unstained exemplary PI-b-PS-b-PFS after thermal annealing at 150° C. under vacuum for four days and subsequent quenching in liquid nitrogen. In FIG. 2B, the PFS cylinders are observed as features with dark cross sections and have an average center-to-center distance of 41.1 nm, but there is effectively no discernable contrast between the PI cylinders and the PS matrix. FIGS. 2C-2F show SEM images of thin film morphologies of the exemplary 82,000 g/mol PI-b-PS-b-PFS (FIG. 2C) and the PI-b-PS-b-PFS blended with 17.9 wt % of mₙ=27,000 g/mol PS homopolymer (PI-b-PS-b-PFS/PS) (FIGS. 2D-2F), where the PFS and PI cylindrical phases orient perpendicular to the surface of the oxidized Si substrate upon which the polymer solutions were deposited. Simultaneously, PI and PS blocks can be removed by oxygen plasma etching to leave oxidized PFS cylinders, leaving the films shown in FIGS. 2C, 2D, and 2F. These films were formed by spin-coating from toluene solution and annealing for 2-5 hours at room temperature in an atmosphere of chloroform. Chloroform was chosen because of its good match in solubility parameter with PS and PFS and its high vapor pressure at room temperature.

The pure triblock terpolymer thin film shown in FIG. 2C has an average thickness of 29.7 nm, and displays regions having hexagonal-packed cylinders and square-packed PFS cylinders with an average center-to-center distance of 39.1 nm. The regions having hexagonal-packed cylinders were determined by TEM analysis of the thin film to have a lower volume fraction of PS than the square-packed regions. The hexagonal-packed features consist of core-shell cylinders with a PFS core and PS shell in a PI matrix. This illustrates the precision needed during the synthesis of the ABC triblock terpolymers, as difference in relative block sizes can adversely affect the desired structure and continuity over the desired surface. However, by blending the PI-b-PS-b-PFS with the 17.9 wt % PS homopolymer, the square-packed pattern extends over the entire sample area with an average center-to-center distance of 40.5 nm, as shown in FIG. 2D. The orientation of the PI cylinders relative to the PFS cylinders is illustrated in FIG. 2E where osmium tetraoxide (OsO₄) was used to stain the PI phase and increase its resistance to oxygen plasma RIE, confirming that the pattern is that illustrated in FIG. 2A. Hence, small errors in triblock terpolymer composition can be corrected by the inclusion of small quantities of one or more homopolymers or diblock copolymers of one or more blocks of the triblock terpolymer.

In an embodiment of the invention, long-range order of the square array may imposed by a template on the substrate to which the ABC triblock terpolymer is deposited. For example, the ABC triblock terpolymer can be deposited on a substrate that is patterned with shallow grooves, which can direct the location of the cylinders in the array and position the features in a controlled manner over a large area. A chemical pattern can also serve as a template to modify the order of the features directed by the grooves. Topographical and chemical templating can be performed in the manner disclosed for diblock copolymer films in Cheng et al., Nat. Mater. 3, 2004, 823 and Jung et al., Nano Letts 7, 2007, 2046, both of which are incorporated herein by reference.

In one embodiment of the invention, the ABC triblock terpolymer is self-assembled in the presence of a template to direct the orientation of the various A, B, and C blocks by the relative affinity of the blocks for the surface of the template. For example, the template can be one or more shallow grooves of one or more desired widths etched into a substrate, for example a semiconductor (e.g., Si), a conductor (e.g., a metal), or an insulator (e.g., silicon oxide, or a polymer). The periodicity of the features and the relative orientation of the features generated due to microphase separation of the blocks within a trench can vary in response to the trench's width and the chemical composition of the surface of the base of the trench and the edge walls of the trench.

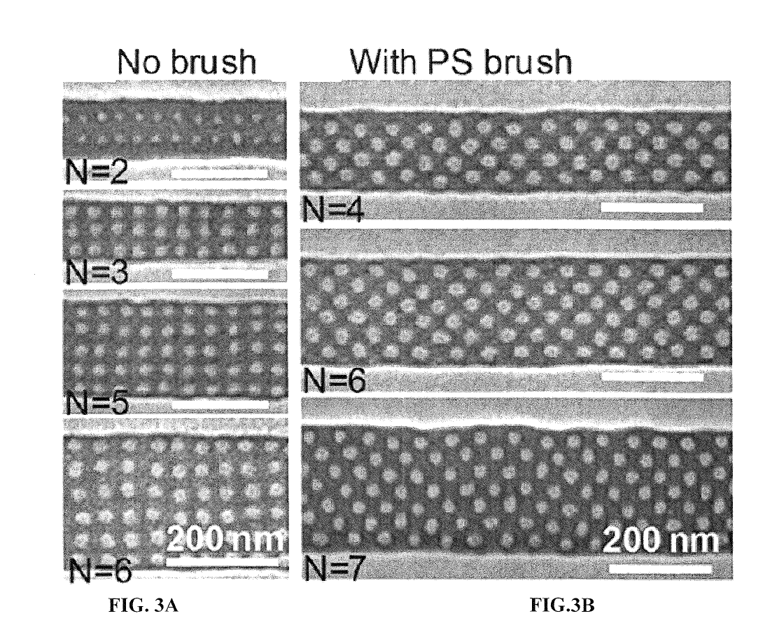

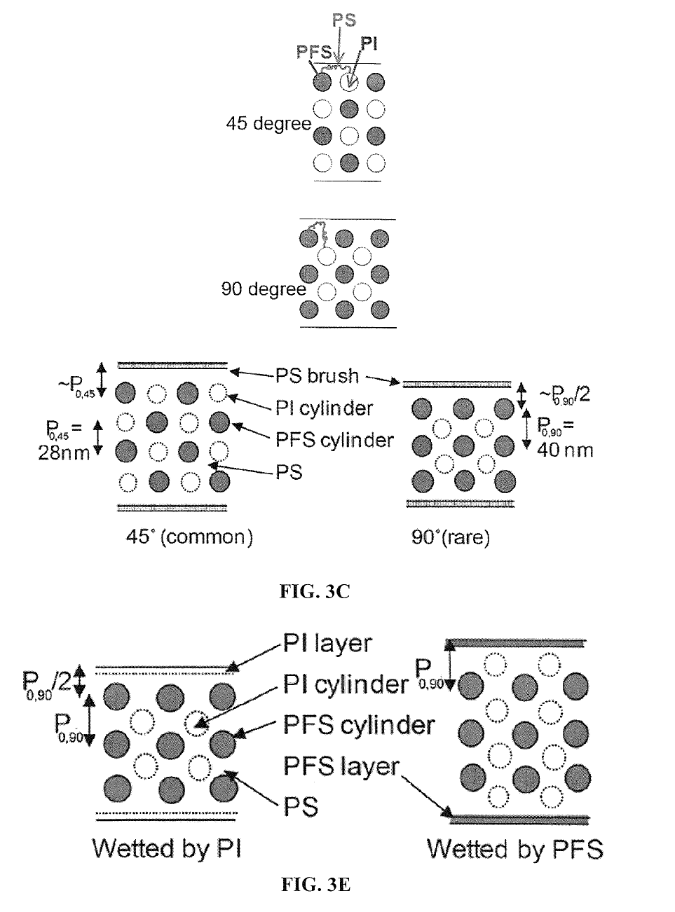

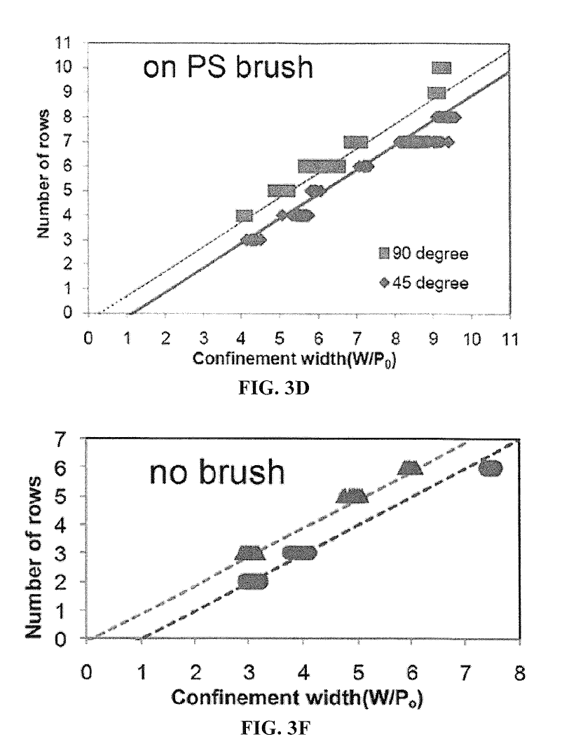

As shown in FIG. 3A, deposition of a PI-b-PS-b-PFS/PS in a trench etched in an oxidized Si substrate, followed by annealing and etching, yields a square array of PFS cylinders with the array's principal axis oriented primarily at 90° relative to the walls of the trench. Referring to FIG. 3B, by coating the templated trench with a PS-brush the PFS features formed an array oriented primarily at 45° to the trench wall. The PS-brush is a surface-confined macromolecular architecture where the PS chains are attached to the substrate surface by one end in close proximity, which forces the chains to stretch out into an extended conformation to minimize segment-segment overlaps. The PS-brushed substrates contain an increasing minority population of 90° and other array orientations as the trench width increases, for example about 16% of the trench's length was occupied by 90°-oriented arrays when the trench width is 235 nm.

The different orientations of the features within the array can result from preferential wetting of the substrate's surface by the blocks, shown schematically in FIGS. 3C and 3E. As the uncoated template made of silicon with its native oxide surface attracts either PI or PFS preferentially to PS, an array results with an orientation having one of the end blocks at the walls, with the adjacent row of cylinders composed entirely of the other end block with the PFS column array oriented 90° to the trench wall. In contrast, the PS-brush coated substrate favors residence of the PS blocks at the walls, where the adjacent row of cylinders consists of alternating PI and PFS, can lead to a 45° orientation of the PFS column array relative to the trench wall.

As the trench width increases, the number of rows of PFS features increases in a stepwise manner. FIGS. 3D and 3F show plots of the number of PFS rows as a function of the confinement width W divided by P₀, where P₀ represents the equilibrium (untemplated) spacing between the rows of PFS posts measured perpendicular to the trench wall. This spacing is P_{0.90}=40.5 nm for the PI-b-PS-b-PFS/PS blend in the 90° orientation and P_{0.45}=40.5/2^{1/2}=28.6 nm in the 45° orientation. FIG. 3D is a plot showing 45° (common) and 90° (rare) orientations for trenches having a PS-brush coating, where both sets of data fit the expected slope of 1. The intercept on the horizontal axis is indicative of the morphology of the features and brush layers present at the trench wall. The 45° array has an intercept of approximately 1, showing that there is a separation of about P_{0.45} (28.6 nm) between the centers of the outer row of PFS microdomains and the trench wall. For the 90° array, the intercept is zero indicating a separation of P_{0.90}/2 of 20.3 nm.

In contrast, FIG. 3F shows similar plots for the uncoated substrates in which the 90° orientation dominates. The data fall onto two lines, one with an intercept of zero and the other with an intercept of 1. These results suggest preferential wetting of some substrates by PI (intercept=0) and others by PFS (intercept=1), as illustrated in FIG. 3E, which may be due to differences in processing of the substrates which affect their preference for PI versus PFS.

Measurements of the period of the PFS posts indicate a rectangular (for the 90°) or oblique (for the 45° orientation) lattice distortion of the 2D square pattern by expansion or contraction of the spacing perpendicular to the trench edge. The distortion, to the period perpendicular to the edge by up to 5-10%, is a response to the incommensurability between confinement width W and P₀, and appears to be analogous to distortion of confined close-packed sphere arrays that have been observed for templated diblock polymers.

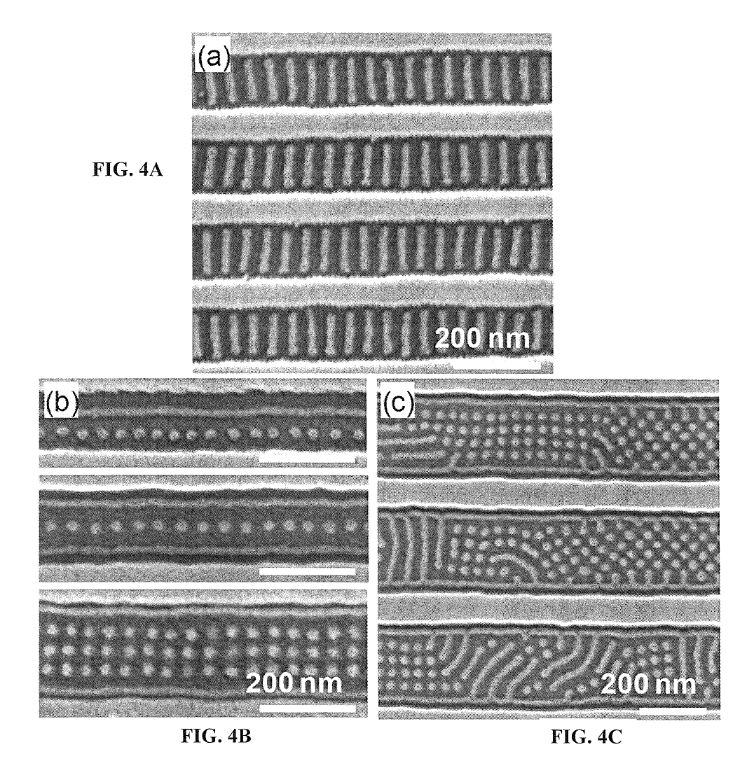

According to an embodiment of the invention, the pattern formed by the ABC triblock terpolymer thin film can be modified by changing the thickness of the film in addition to the templating. In one embodiment, in-plane cylinders of PFS from the same PI-b-PS-b-PFS/PS blend described above can be formed, but with film thickness of about 35 nm. FIG. 4A shows that deposition of the PI-b-PS-b-PFS/PS blend in trenches having a PS-brush surface results in PFS and PI cylinders that lie perpendicular to the trench walls but do not contact these PS brush coated walls. In contrast, as shown in FIG. 4B, untreated trenches show patterns that are a mixture of parallel and perpendicular cylinders of PI-b-PS-b-PFS/PS blend with the pattern dependent upon the width of the trench for relatively narrow trenches. These narrow trenches contain in-plane PFS cylinders parallel to the untreated oxidized Si trench walls as well as rows of cylinders oriented perpendicular to the substrate base. When the trenches exceed a certain width, a variety of morphologies form in the about 35 nm triblock terpolymer film, as shown in FIG. 4C, including branched cylinders and 90° and 45° oriented arrays. The separation between the in-plane cylinders and the trench edge suggests that PI wets the trench walls in these 35 nm thick triblock terpolymer films.

Hence, by tuning the film thickness, the relative affinity of the trench wall to a specific block of the ABC triblock terpolymer, and the dimensions of the trench, desired cylindrical phases of blocks can be oriented in-plane or out-of-plane where the angle between the trench wall and the principal axes of the cylinder lattice can be controlled in a manner similar to that described with respect to FIGS. 3A-3F. Structures where the cross-section resemble the 45 and 90° orientations of FIGS. 3C and 3E are formed when the confining planes are neutral to both end blocks, A and C. However, if the planes are attractive to central block B, the 45° orientation becomes more favorable, possibly because it minimizes extended, less-favored conformations of the B block polymer backbone. The morphology of FIG. 4A with A and C cylinders perpendicular to the trench walls and parallel to the trench base is promoted in thicker films where the B block is attracted to the trench wall, with the A and C block cylinders terminating without touching the trench walls.

According to embodiments of the invention, self assembly of ABC triblock terpolymers can result in morphologies other than square arrays. In one embodiment of the invention, parallel lamellae of A, B, and/or C can be arranged in a desired sequence, for example, ABCBABC after selectively removing one or two of the blocks. By appropriate choice of the volume fraction of the three blocks various structural options are possible, including narrow polymer lines with a wide spacing and wide polymer lines with a narrow spacing. The use of the ABC triblock terpolymers allows this structural selectivity, unlike lamellar structures that can be formed with AB diblock copolymers where the A and B blocks must be of similar volume fraction, which only allows the generation of lines with approximately equal dimensions. In one embodiment of the invention by employing an ABC triblock terpolymer where the B block is a relatively small volume fraction, alternating lamellae of A and C can display cylinders or spheres of B at their interface. Selective etching allows the production of a pattern of lines containing periodic bumps or notches.

In another embodiment of the invention, the pattern formed by the ABC triblock terpolymer comprising films can be transferred to other materials via the selective etching of one or more blocks of the ABC triblock terpolymer comprising film. This triblock terpolymer lithography is promoted by having a good etch selectivity between the blocks. In an exemplary embodiment of the invention, organic blocks of a triblock terpolymer, such as PS-b-PFS-b-P2VP or PI-b-PS-b-PFS, can be selectively removed using oxygen RIE to leave partly oxidized organometallic PFS cylindrical posts.

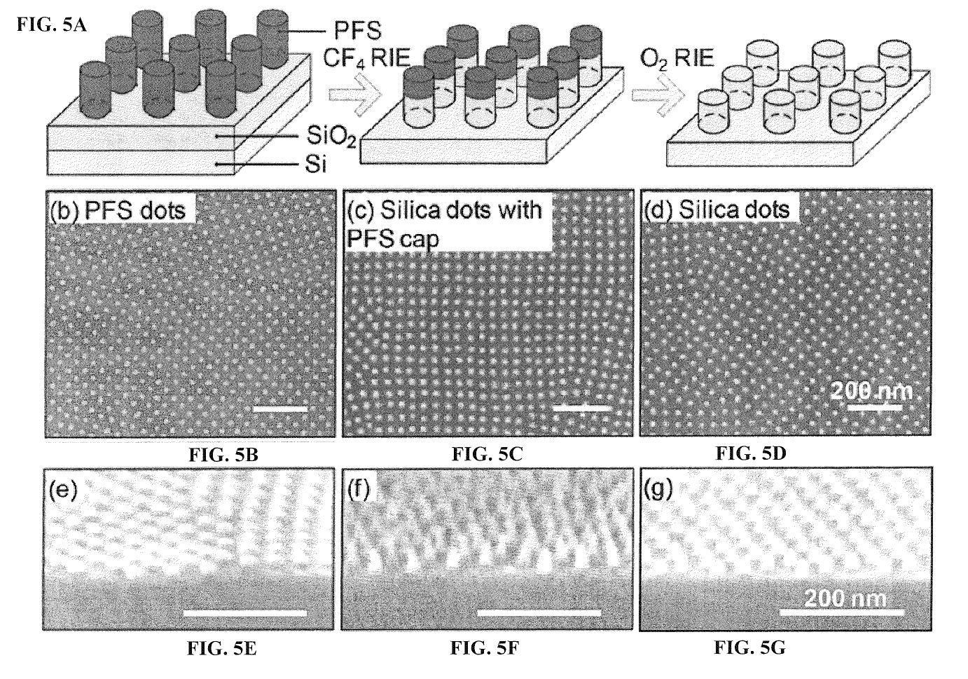

Referring to FIG. 5A, once a self-assembled pattern of the ABC triblock terpolymer comprising film has been etched such that only one or two blocks of the ABC triblock terpolymer film remain, for example in a square pattern, the pattern of the remaining blocks of the ABC triblock terpolymer film can be transferred to a material on the substrate. In the exemplary embodiment shown in FIG. 5A, PFS cylindrical posts remain on the SiO₂/Si substrate after removing the PS and PI blocks of a PI-b-PS-b-PFS triblock terpolymer (see also FIGS. 5B and 5E). Then, a reactive ion etch (RIE) of the SiO₂ using the PFS cylindrical posts as an etchmask can be performed (see also FIGS. 5C and 5F). The RIE can use CF₄ as the etchant. Then, any remaining PFS of the etchmask can be removed using for example an O₂ RIE (see also FIGS. 5D and 5G).

According to an exemplary embodiment of the invention, the square-packed PFS cylindrical post array deposited on an uncoated silica substrate can be employed to form silica posts having a height of about 30 nm and an aspect ratio (height/diameter) of about 1.6. This aspect ratio of the silica posts can be less than or greater than that of the PFS posts used for their formation, which in the exemplary embodiment have an aspect ratio of about 1, as the relative aspect ratio depends on the thickness of the silica layer and the thickness of the deposited ABC triblock terpolymer comprising film. The cross-sectional images of FIGS. 5B, 5C and 5D are consistent with the vertically oriented PFS cylinders extending throughout all or most of the film thickness. This PFS cylinder pattern allows the CF₄ etching of the silica not covered by the PFS posts followed by the removal of the PFS posts by O₂ RIE to yield a square array of silica posts having a diameter of 20 nm, a height of 30 nm and a period 40 nm from a 30 nm thick silica film.

As illustrated in FIGS. 5A-5G, nanoscale device features can be patterned onto substrates using self-assembled ABC triblock polymer films.

All patents, patent applications, provisional applications, and publications referred to or cited herein are incorporated by reference in their entirety, including all figures and tables, to the extent they are not inconsistent with the explicit teachings of this specification.

Any reference in this specification to “one embodiment,” “an embodiment,” “example embodiment,” etc., means that a particular feature, structure, or characteristic described in connection with the embodiment is included in at least one embodiment of the invention. The appearances of such phrases in various places in the specification are not necessarily all referring to the same embodiment. In addition, any elements or limitations of any invention or embodiment thereof disclosed herein can be combined with any and/or all other elements or limitations (individually or in any combination) or any other invention or embodiment thereof disclosed herein, and all such combinations are contemplated with the scope of the invention without limitation thereto.

It should be understood that the examples and embodiments described herein are for illustrative purposes only and that various modifications or changes in light thereof will be suggested to persons skilled in the art and are to be included within the spirit and purview of this application.

What is claimed is:

1. A self-assembled film comprising an ABC triblock terpolymer disposed on a substrate surface and having a controlled pattern of features over the entire film.

2. The self-assembled film according to claim 1, wherein the film has a thickness of less than 50 nm.

3. The self-assembled film according to claim 1, wherein the features have at least one dimension other than thickness that is similar to the thickness of the film.

4. The self-assembled film according to claim 1, wherein the block B comprises a continuous phase in the film.

5. The self-assembled film according to claim 1, wherein the features comprise columns of at least one of the terminal A and C blocks of the ABC triblock terpolymer.

6. The self-assembled film according to claim 5, wherein the columns of a given block are disposed as rows in a square lattice array where the columns are perpendicular to the substrate surface upon which the film is deposited.

7. The self-assembled film according to claim 6, wherein the rows are oriented perpendicular to an edge wall residing perpendicular to the substrate surface.

8. The self-assembled film according to claim 6, wherein the rows are oriented at a 45° angle to an edge wall perpendicular to the substrate surface.

9. The self-assembled film according to claim 1, wherein the substrate surface has a preferential affinity for one or two of blocks A, B and C of the ABC triblock terpolymer.

10. The self-assembled film according to claim 9, wherein the substrate surface comprises a polymer brush of homopolymer A, homopolymer B, or homopolymer C.

11. The self-assembled film of claim 1, wherein the features comprise lamella of blocks A, B, and C in a repetitive sequence.

12. The self-assembled film according to claim 1, wherein the features comprise lamella of blocks A, B, and C in a repetitive sequence having the A and C lamella separated by the B lamella.

13. The self-assembled film according to claim 1, wherein the film further comprises one or more of homopolymer A, homopolymer B, homopolymer C, diblock copolymer AB, diblock copolymer BC, and diblock copolymer AC.

14. A method for triblock terpolymer lithography comprising:
providing an ABC triblock terpolymer comprising material;
providing a substrate having a surface;
depositing the ABC triblock terpolymer comprising material as a film on the substrate surface, wherein the film has a thickness of about 50 nm or less;
structuring the film into a self-assembled pattern of features, wherein a feature comprises a microdomain of block A, block B, or block C of the ABC triblock terpolymer; and
transforming at least one of the block A, block B, or block C comprising features of the film situated on at least a portion of the substrate.

15. The method according to claim 14, wherein transforming comprises modification, removal and/or replacement of at least one of the A block, B block or C block comprising features.

16. The method according to claim 15, further comprising transferring at least a portion of the pattern of features onto the substrate subsequent to transforming at least one feature of the film.

17. The method according to claim 14, wherein transforming the at least one of the block A, block B, or block C comprising features transforms more than one of the blocks, wherein the transforming of the more than one of the blocks is performed simultaneously or sequentially.

18. The method according to claim 14, wherein the transforming of the at least one of the block A, block B, or block C comprising features is promoted by one or more transforming agents.

19. The method according to claim 14, wherein the ABC triblock terpolymer comprising material further comprises one or more of homopolymer A, homopolymer B, homopolymer C, diblock polymer AB, diblock polymer BC, and diblock polymer AC.

20. The method according to claim 14, wherein the self-assembled pattern of features comprises a square lattice array of columns comprising the terminal A block and columns comprising the terminal B block.

21. The method according to claim 14, wherein the ABC triblock terpolymer comprising material has a narrow size distribution of the A block, B block, and C block, and has volume fractions of A block, B block, and C block that direct the self-assembled pattern of features on the substrate surface, and wherein the substrate surface's composition and geometry further directs the self-assembled pattern of features.

22. The method according to claim 21, wherein the substrate surface's composition has a selective affinity for one or two of the A block, B block, and C block.

23. The method according to claim 21, wherein the substrate surface's geometry comprises a trench comprising a base and edge walls.

24. The method according to claim 23, wherein the self-assembled pattern of features comprises a square lattice array of columns situated perpendicular to the substrate surface upon which the film is deposited where rows of the columns are oriented perpendicular or at a 45° angle to at least one of the edge walls.

25. The method according to claim 24, wherein the self-assembled pattern of features further comprises at least one column situated parallel to the edge walls and the base.
